(19) United States
(12) Patent Application Publication
(10) Pub. No.: US 2007/0226046 A1
(43) Pub. Date: Sep. 27, 2007

(54) Sales agent feedback system

(76) Inventor: Matthew Ivan Share, Marietta, GA (US)

Correspondence Address: Donald W. Meeker;Patent Agent, 924 East Ocean Front #E, Newport Beach, CA, 92661, US

(21) Appl. No.: 11/728,465

(22) Filed: Mar. 26, 2007

Related U.S. Application Data
(60) Provisional application No. 60/743,795, filed on Mar. 27, 2006.

(51) Int. Cl. G07G 1/00

(52) U.S. Cl. 705/10

(57) ABSTRACT

A programmed system and method using software and a web site set up for buyer's agent promotional content which provides potential buyer feedback information automatically to a seller's agent. The seller's agent and seller view the buyer's agent web site which promotes the buyer's agent's for sale offerings which might be picked up as buying opportunities by the seller's agent.

### CROSS-REFERENCE TO RELATED APPLICATIONS

The present utility patent application claims the benefit of provisional application No. 60/743,795, filed Mar. 27, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to web based feedback information management programs and particularly to a web based software program for reporting on prospective buyer reactions to whatever is being sold, such as real estate, yachts, or any expensive sales items so that the person viewing a web site containing the feedback information will also view what the buyer agent is offering for potential business transactions with the buyer agent then becoming a potential seller agent of another offering to the seller agent who becomes a buyer agent for the web site agent.

2. Description of Related Art Including Information Disclosed Under 37 CFR 1.97 and 1.98

It can be appreciated that the desire for sales related feedback has been around for years. Typically, this communication is initiated by sellers or their agents in an informal and inconsistent manner by a phone call or email. In some industries, automated feedback systems exist; but in such cases, the feedback request is initiated by the seller.

For this reason, potential buyers and their agents do not often reply because they do not obtain any direct or immediate benefit by replying. Additionally, these methods create a lost opportunity for potential buyers and/or their agents to expose sellers or their agents to information of the buyer's agent's choosing such as advertisements.

In these respects, the present invention substantially departs from the conventional methods in that the feedback process is initiated by the potential buyer and/or their agent.

While a number of published patent applications and a couple of patents provide selling agent electronic communication of potential buyer feedback, none of them seem to provide a web site set up for agent advertising which provides potential buyer feedback.

U.S. Patent Application #20050288958, published Dec. 29, 2005 by Eraker, claims an online marketplace for real estate transactions. In an embodiment of the invention, a web site system maintains a real estate web page. The web page has an aerial image map of a geographic region that can be navigated by a user. The web site system facilitates online collaboration for real estate transactions. When the user registers, the system creates a user account for real estate information. Real estate agents and/or other real estate service providers selected by the user are granted shared access to the user's account by the web site system. The real estate web site system also provides a showing tool to collect feedback from real estate property showings.

U.S. Patent Application #20050096926, published May 5, 2005 by Eaton, discloses a system and method for automating the transfer of real estate. A centralized server or servers are connected to a distributed computer network that is connected between a plurality of client computers. A real estate record is created on the centralized server and information is received on the server from a plurality of sources including real estate databases, computer input devices, facsimile equipment, and electronic mail systems. The centralized server is integrated with a multiple listing service wherein information can be automatically exchanged therebetween. Fax or email communications may include documents for storage on the server. The fax or email sender enters a record identifier wherein the server recognizes the record identifier and determines whether it matches an existing real estate record. If so, the server converts the document to digital form if necessary and saves it to the matching real estate record. An agent who wishes to inspect a property with a client requests and schedules a showing through the property listing agent. The showing agent is granted access to a specific subset of listing information for the property. After the showing, the showing agent is requested to enter feedback on the showing.

U.S. Patent Application #20040049406, published Mar. 11, 2004 by Muncaster, describes a wireless intelligent real estate electronic lock box. The intelligent real estate system includes an intelligent real estate sign having embedded processing functionality and a wireless communication device capable of receiving wireless electronic queries and programming instructions and for communicating with local and remote information sources about a real estate property and with controlling agents for reporting status. Further included is an electronic lock box controlling access to the real estate property and having an embedded wireless communication device capable of receiving messages and control signals from the real estate sign and from a property owner/occupant and/or real estate agents for reporting status. An earth battery may also be included, at least partially contained within the real estate sign and supplying power to the real estate sign. The wireless communication system may support such features as, for example, recording feedback concerning the property from an agent and/or potential buyers. Further, a buyer's agent or a prospective buyer may post private messages, comments and questions directly to the seller or seller's agent. Such messages may include, but are not limited to, suggestions for making the property show better, for example.

U.S. Patent Application #20060106628, published May 18, 2006 by Faherty, indicates a centralized system and method for notifying occupant of completion of home showing for facilitating sale of a home in which an occupant is absent. A resident communications system is installed at the home. Upon completion of a showing at the home by a real estate agent, a signal is transmitted from the resident communication system. The signal can be a home identifier that is subsequently received by a centralized showing system, which correlates the home identifier with a logical address of a handheld communications device carried by the occupant, and contacts and informs the occupant via the handheld communications device that the home showing has been completed. Or the signal can be a notification signal that is transmitted directly to the handheld communications device for notifying the occupant that the home showing has been completed. The resident communications system may have a base unit and a remote unit, such as a lockbox, that can be placed near the ingress/egress of the home and actuated to transmit an activation signal to the base unit, which then transmits the signal to centralized showing system or directly to the handheld communications device. Each resident communications system may optionally be configured for receiving subjective showing feedback information (e.g., the likes and dislikes of the showing agent and/or potential buyer, recommendations on pricing, decorations, maintenance, etc.) and/or objective showing feedback information (e.g., the time, date, and duration of the showing). The subjective and objective showing feedback information can either be entered into by the showing agent, or otherwise acquired by, the remote unit, in which case, it can be transmitted (either wirelessly or via wire) to the base unit, or the subject and objective showing feedback information can be directly entered into by the showing agent, or otherwise directly acquired by, the base unit. If a lockbox is used for the remote unit, the lockbox can be provided with a clock and a processor that can automatically track the initiation and subsequent completion of a showing in order to automatically acquire the objective showing feedback information. Alternatively, the remote unit or base unit can have a multitude of buttons that can be operated by the showing agent to rank the home (single column of buttons) or different home categories (multiple columns of buttons). The home identifier can optionally be transmitted from the resident communications system in response to operative of one of these buttons. In any event, the subject and objective information can either be stored in the resident communications system for playback by the occupant, or can be transmitted to the centralized showing system using a communications means.

Four U.S. Patent Applications, #20020022980 published Feb. 21, 2002; #20020035493 published Mar. 21, 2002; and #20020046077 and #20020046069 published Apr. 18, 2002 by Mozayeny, put forth a method and system for scheduling real estate appointments. The method comprises receiving from a showing realtor a request to show property, and automatically communicating the request to show property to a seller of the property, the act of communicating including soliciting appointment approval from the seller. After a property has been shown by a showing agent, the appointment server may automatically request feedback from the showing agent. To automatically request this feedback, the appointment server may simply request the feedback the day of the showing or the day after a showing was scheduled. The feedback may be requested by IVR, web page forms, or by e-mail. After the feedback has been received by the appointment server from the showing agent, the feedback may be automatically communicated by e-mail or otherwise to the listing agent. In another embodiment, the feedback request may be directed to the showing agent but then sent via e-mail directly to the listing agent. The listing agent may then communicate feedback and other information to the seller of the property via traditional methods to ensure that a personal and professional relationship is maintained.

Four U.S. Patent Applications, #20040039629 published Feb. 26, 2004 and #20030220805, #20030220807 and #20030220898 published Nov. 27, 2003 by Hoffman, concern a web based automated method and system for managing and/or transferring real estate information for tracking the activities involved in selling, buying, or leasing a property. In an embodiment of a real estate transaction system of the invention, several modules have been communicatively coupled to provide a complete and reliable system of tracking buyers' and sellers' activities and keeping a Realtor informed and prepared at all times. A showing module gathers information from prospective buyers for a Realtor, compiles this information and then makes the information available to the seller. Preferably, a prospective buyer will tell the Realtor their opinion about a property, then in turn the buyer's Realtor would tell the seller's Realtor, who, finally, tells the seller, where the showings module facilitates the communication between the Realtors. The showings module can also be used to provide feedback to a seller from a prospective buyer.

U.S. Patent Application #20030204406, published Oct. 30, 2003 by Reardon, illustrates a system for marketing real estate which includes a property data device and a personal data device. The property data device is to be located in the vicinity of a real estate property, and the personal data device is to be provided to a user. The property data device is operable to transmit the property information data, and the personal data device operable to receive and store the property information data transmitted by the property data device. An embodiment includes the gathering of buyer feedback for a property. The user may provide feedback via the second data device to the first data device. Alternatively, feedback information may be transmitted from the second data device to the information database. The feedback may include favorable or unfavorable opinion data about the property. The feedback information is then stored in the information database and can be used to generate further reports related to the property. The user may provide the feedback information voluntarily, or the user may be offered an incentive to provide the information.

U.S. Pat. No. 6,624,742, issued Sep. 23, 2003 to Romano, is for a wireless intelligent real estate electronic lock box. The intelligent real estate system includes an intelligent real estate sign having embedded processing functionality and a wireless communication device capable of receiving wireless electronic queries and programming instructions and for communicating with local and remote information sources about a real estate property and with controlling agents for reporting status. Further included is an electronic lock box controlling access to the real estate property and having an embedded wireless communication device capable of receiving messages and control signals from the real estate sign and from a property owner/occupant and/or real estate agents for reporting status. An earth battery may also be included, at least partially contained within the real estate sign and supplying power to the real estate sign. The wireless communication system may support such features as, for example, recording feedback concerning the property from an agent and/or potential buyers. Further, a buyer's agent or a prospective buyer may post private messages, comments and questions directly to the seller or seller's agent. Such messages may include, but are not limited to, suggestions for making the property show better, for example.

U.S. Pat. No. 3,981,087, issued Sep. 21, 1976 to Sachs, provides a teaching machine adapted to take account of the student's ability and progress operates with programmed cards and includes three stacking means, controlled conveyor means, display means and a student input means, such as a keyboard. An alternate embodiment provides a keyboard connected so that a prospective buyer can comment to himself on individual items, so that he can remember his reaction, from the last time through, to a particular item. These comments may also be most useful to the prospective seller where only one or a smaller number of the characteristics of the item being considered are in question. For instance, a house might be a possibility if the price were lower, and the porch screened, so the user comments to this effect using the keyboard. When his use is finished, the cards could again be run through the machine from reserve stack to reject stack by the salesman, where the results could be fed to a computer line through connector and the collected final comments assembled for possible action by the sellers of the homes commented on. Such a mechanism would be advantageous for the seller in that it would provide feedback concerning the problems he is having selling his property, and provide specific suggestions for how he could make the property more salable. Further, it might give him the opportunity to make a sale under conditions slightly different from those he had originally set up.

What is needed is a programmed system and method using software and a web site set up for buyer's agent advertising which provides potential buyer feedback automatically to a seller's agent which requires the seller's agent to view the buyer agent web site which promotes the buyer's agent's for sale offerings which might be picked up as buying opportunities by the seller's agent.

### BRIEF SUMMARY OF THE INVENTION

An object of the present invention is to provide a programmed system and method using software and a web site set up for buyer's agent advertising which provides potential buyer feedback information automatically to a seller's agent which requires the seller's agent to view the buyer agent web site which promotes the buyer's agent's for sale offerings which might be picked up as buying opportunities by the seller's agent.

In brief, the present invention is a system and method facilitating mutually beneficial communications and transactions between and among agents representing both buyers and sellers. The present invention uses a data repository and network to store feedback information and communicate notification of the feedback information from buyer's agents and their respective potential customers to seller's agents for the purpose of enticing seller's agents to communicate with and transact business with buyer's agents.

When using this system and method, product feedback information will originate from buyers and their agents and can be stored in a network-connected data store via many different alternatives including but not limited to the following:

1. Data is collected on a non-networked electronic device such as a laptop computer or PDA and stored locally on the device itself. Later, the data from the device is transferred to the network-connected data store when the hand-held device is connected to the network either directly or the data is transferred to another device that is network connected. A software application layer may be used to facilitate the transfer of the data.
2. Data is collected on a network-connected device such as a laptop computer or PDA and is immediately written to the data store via a wired or wireless network connection using standard communication protocols such as TCP/IP. A software application layer may be used to facilitate the collection and transfer of the data to the data store.
3. Data is collected in a non-electronic form such as pen and paper. Later the data is transcribed onto a computer that is network connected and the data is transferred to the network-connected data store. A software application layer may be used to facilitate the transfer of the data.

The resulting feedback information will then be transmitted to the data repository via a wired or wireless network.

Subsequently, a notification of the existence of buyer feedback information will be generated and communicated to the seller and/or the seller's agent. The notification may be sent via email, fax, text message, telephone, or any other viable communication method. The seller and/or the seller's agent will navigate to the buyer's agent's URL (Web page) and authenticate their identity in order to access the feedback information.

The present system of feedback creates a unique opportunity for the buyer's agent to expose the seller's agent to information of his or her choosing, including but not limited to advertisements or other promotional content.

Since individual buyers' agents will be communicating with a multiplicity of seller's agents who may themselves also act as buyer's agents, this system and method will create a unique and valuable business network that will enable and facilitate mutually beneficial communications and transactions between and among a multiplicity of agents.

Once the data is entered into the network-connected data store via one of the aforementioned methods, a software application generates a notification of the existence of buyer feedback information and communicates it to the seller and/or the seller's agent. The notification can be sent via email, fax, text message, telephone, or any other viable communication method.

When a seller and/or a seller's agent receives notification of feedback, he will utilize a Web browser and navigate to the buyer's agent's URL (Web page) and authenticate their identity in order to access the feedback information.

One thing that really differentiates the present invention is the fact that due to the addition of the unique advertising component of it, the sales person who is working with the potential buyer has a reason to proactively submit feedback information after showing the product (in this case real estate) rather than the seller or seller's agent “requesting” that the buyer or buyer's agent provide feedback as a favor to them with no benefit to do so. In the present invention, the feedback process is initiated by the buyer's agent which is unique.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view showing the key components of the present invention.

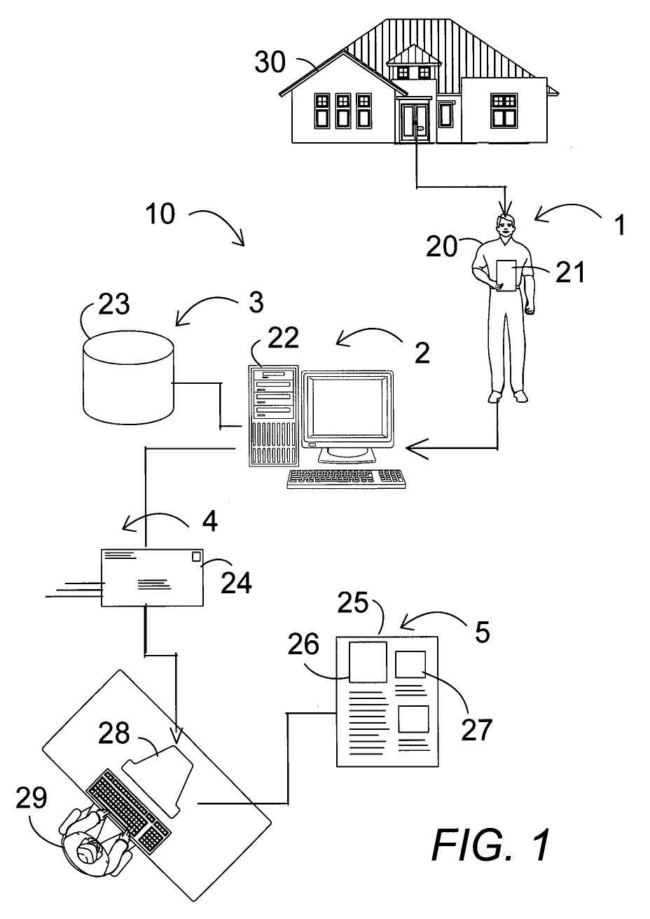

The drawings in FIG. 1 refer to a real estate industry specific example. This example is used for clarification purposes only and is not intended to minimize the scope of this invention to the real estate industry only. The same system and method could be applied to any industry in which products or items of high value are bought and sold.

### DETAILED DESCRIPTION OF THE INVENTION

In FIG. 1, a system 10 comprises a variety of software applications, computer equipment 22 and 28 interconnecting with a server 23 on the world wide web and other communication devices for a buyer's agent 20 to provide automatic feedback information 26 to a seller's agent 29 via a web site 25 displaying the buyer's agent's promotional content 27 as well as the feedback information 26.

A means for recording feedback information 21 about a sales offering by a buyer's agent 20, shown at step 1, may comprise at least one recording means taken from the list of recording means including an electronic hand-held device, a computer, a PDA, a sound recording, and a hand written recording media or other recording means.

A software application program in a computer 22 comprises a means for entering the feedback information 26, shown at step 2, into a database serving a web site 25 on the server 23 on the world wide web, the web site 25 displaying promotional content 27 presented by the buyer's agent 20 as well as the feedback information 26.

A means for automatically notifying the seller's agent 29 of the posting of the feedback information on the web site 25, wherein a software application program in a buyer's agent's computer 22 automatically generates a notification about the feedback information on the web site and sends the notification to the seller's agent and the seller by a means for communicating information 24, which may include at least one communication means taken from the list of communication means comprising email, fax, text message, automated telephone call, and mail.

A software program in the buyer's agent's computer 22 automatically generates a unique login username and password means for the seller's agent 29 and the seller to access and view the feedback information 26 and the promotional content 27 on the web site 25.

The means for the seller's agent 29 and the seller to access and view the feedback information 26 and the promotional content 27 on the web site 25 comprises a software program which recognizes the unique login username and password and opens the web site file for viewing.

A method for a buyer's agent 20 to provide automatic feedback information 26 to a seller's agent 29 via a web site 25 with buyer agent promotional content 27 comprises a series of steps using a system 10 comprising a variety of software applications, computer equipment 22 and 28 interconnecting with a server 23 on the world wide web and other communication devices for a buyer's agent 20 to provide automatic feedback information 26 to a seller's agent 29 via a web site 25 displaying the buyer's agent's promotional content 27 is well as the feedback information 26.

A first step 1 comprises recording feedback information about a sales offering by a buyer's agent 20 using a means for recording the feedback information 21, which might comprise using at least one recording means taken from the list of recording means including an electronic hand-held device, a computer, a PDA, a sound recording, and a hand written recording media such as pen and paper or other recording means as the means for recording the feedback information.

A second step 2 comprises entering the feedback information 26 into a software program with a database in a buyer's agent's computer 22.

A third step 3 of uploading the feedback information 26 and buyer's agent promotional content 27 for a web site 25 onto a server 23 serving a web site 25 on the World Wide Web by using a software application program on the buyer's agent's computer 22.

A fourth step 4 comprises automatically notifying the seller's agent 29 of the posting of the feedback information 26 on the web site 25 by a means for automatically notifying the seller's agent 29 using a software application program which automatically generates a notification 24 about the feedback information 26 on the web site 25 and sends the notification to the seller's agent and the seller by a means for communicating information, which might include at least one communication means taken from the list of communication means comprising email, fax, text message, automated telephone call, and mail. The third step 3 further comprises automatically providing the seller's agent 29 and the seller with a means for accessing the web site 25 using a software program which automatically generates a unique login username and password as the means for accessing the web site.

A fifth step 5 comprises using a software program which recognizes the unique login username and password and opens the web site file for viewing as the means for allowing the seller's agent 29 and the seller to access and view the feedback information 26 and the promotional content 27 on the web site 25.

In use, the present invention can be best understood when seen in the context of an industry-specific example. The real estate industry provides such an example. However, application of the present invention is not limited to the real estate industry. For purposes of clarification only, sellers' agents are referred to as listing agents within the context of this industry specific example.

Real estate agents have been finding ways of obtaining feedback information when their listed properties have been shown. Conventionally, the listing agent contacts the potential buyer's agent and asks the buyer's agent to do them a favor by responding with feedback information. In many cases no response is given since the buyer's agent does not have an immediate or direct benefit by providing such information.

Since real estate buyers' agents often have listings as well, a buyer's agent could use the present invention by logging information about a property while they are on-site with or without their client. They could log the feedback information electronically or use a manual logging processing and later transcribe the data into electronic form. Ultimately, a notification would be sent to the listing agent and/or their seller to let them know that the buyer's agent had left them feedback information about their listed property. The listing agent would then be required to log on to the buyer's agent's web site to view the feedback information. This is a mutually beneficial scenario for the following reasons:

Since buyer's agents often have listings of their own, the buyer's agent benefits by combining the feedback information with promotional content such as advertisements for other listings of theirs as well as any other information that they wish to communicate to the listing agent.

Since both the listing agent and the showing agent receive a benefit from the feedback communication, use of the present system and method will likely increase the percentage of showings that provide feedback; thereby enabling the listing agent to identify correctable shortcomings and fix them to facilitate a quicker sale of the property.

The seller's agent can decide to share the feedback information that they receive with other parties (such as the seller that they represent). Again, if the seller's agent chooses to do this then the actual seller (not just their agent) will be viewing advertising as well (perhaps advertising that could lead to them choosing the agent who uses this unique, patented process when their listing expires with their current agent).

Since the showing agent knows that they are going to be providing feedback while they are on-site at the property, the quality of the feedback information will be improved because the showing agent will document their thoughts and comments while at the property rather than trying to remember a property that they looked at several days prior when the listing agent finally contacts them through the conventional feedback method.

It is apparent from this example that the system and method of feedback as described in this document creates a unique and valuable business network that will enable and facilitate mutually beneficial communications and transactions between and among a multiplicity of agents.

The present invention could apply to other industries and is not necessarily limited to the real estate industry. It could really apply to any high priced and non-commodity purchase.

It is understood that the preceding description is given merely by way of illustration and not in limitation of the invention and that various modifications may be made thereto without departing from the spirit of the invention as claimed.

What is claimed is:

1. A system for a buyer's agent to provide automatic feedback information to a seller's agent via a web site with buyer agent promotional content, the system comprising:
means for recording feedback information about a sales offering by a buyer's agent;
means for entering the feedback information into a database;
means for uploading the feedback information along with buyer's agent promotional content onto a server serving a web site on the world wide web;
means for automatically notifying the seller's agent of the posting of the feedback information on the web site and automatically providing the seller's agent and the seller with a means for accessing the web site;
means for the seller's agent and the seller to access and view the feedback information and the promotional content on the web site.

2. The system of claim 1 wherein the means for recording feedback information about a sales offering comprises at least one recording means taken from the list of recording means including an electronic hand-held device, a computer, a PDA, a sound recording, and a hand written recording media.

3. The system of claim 1 wherein the means for entering the feedback information comprises a software database program.

4. The system of claim 1 wherein the means for entering the feedback information comprises a software application program.

5. The system of claim 1 wherein the means for automatically notifying the seller's agent of the posting of the feedback information on the web site comprises a software application program which automatically generates a notification about the feedback information on the web site and sends the notification to the seller's agent and the seller by a means for communicating information.

6. The system of claim 5 wherein the means for communicating information comprises at least one communication means taken from the list of communication means comprising email, fax, text message, automated telephone call, and mail.

7. The system of claim 1 wherein the means for accessing the web site comprises a software program which automatically generates a unique login username and password.

8. The system of claim 7 wherein the means for the seller's agent and the seller to access and view the feedback information and the promotional content on the web site comprises a software program which recognizes the unique login username and password and opens the web site file for viewing.

9. A method for a buyer's agent to provide automatic feedback information to a seller's agent via a web site with buyer agent promotional content, the method comprising:
a first step of recording feedback information about a sales offering by a buyer's agent using a means for recording the feedback information;
a second step of entering the feedback information into a database program on a buyer's agent's computer by a means for entering information;
a third step of uploading the feedback information along with buyer's agents promotional content in a web site program to a server serving a web site on the world wide web by a means for uploading the feedback information and the promotional content;
a fourth step of automatically notifying the seller's agent of the posting of the feedback information on the web site by a means for automatically notifying the seller's agent and automatically providing the seller's agent and the seller with a means for accessing the web site using a means for automatically providing the seller's agent and the seller with a means for accessing the web site;
a fifth step of allowing the seller's agent and the seller to access and view the feedback information and the promotional content on the web site by a means for allowing access and viewing of the web site.

10. The method of claim 9 wherein the first step comprises using at least one recording means taken from the list of recording means including an electronic hand-held device, a computer, a PDA, a sound recording, and a hand written recording media as the means for recording the feedback information.

11. The method of claim 9 wherein the second step comprises using a software database program as the means for entering the feedback information.

12. The method of claim 9 wherein the third step comprises using a software application program as the means for uploading the feedback information along with buyer's agent promotional content in a web site program onto a server serving a web site on the World Wide Web.

13. The method of claim 9 wherein the fourth step comprises automatically notifying the seller's agent of the posting of the feedback information on the web site using a software application program which automatically generates a notification about the feedback information on the web site and sends the notification to the seller's agent and the seller by a means for communicating information.

14. The method of claim 13 wherein the fourth step comprises using at least one communication means taken from the list of communication means comprising email, fax, text message, automated telephone call, and mail as the means for communicating information.

15. The method of claim 1 wherein the fourth step further comprises using a software program which automatically generates a unique login username and password as the means for accessing the web site.

16. The method of claim 15 wherein the fifth step comprises using a software program which recognizes the unique login username and password and opens the web site file for viewing as the means for the seller's agent and the seller to access and view the feedback information and the promotional content on the web site.
